(19) United States
(12) Patent Application Publication
(10) Pub. No.: US 2014/0257908 A1
(43) Pub. Date: Sep. 11, 2014

(54) VIEWER PATTERN ANALYSIS

(71) Applicant: AVAYA INC., Basking Ridge, NJ (US)

(72) Inventors: Robert C. Steiner, Broomfield, CO (US); Marc A. Geist, Broomfield, CO (US)

(73) Assignee: Avaya Inc., Basking Ridge, NJ (US)

(21) Appl. No.: 13/788,735

(22) Filed: Mar. 7, 2013

(51) Int. Cl. G06Q 10/06

(52) U.S. Cl. CPC G06Q 10/06313
USPC 705/7.23

(57) ABSTRACT

A microprocessor executable analytic module is provided that determines, for each of a plurality of selected contact center objects, a visually perceptible parameter based on contact center information and/or a performance parameter and provides a display incorporating the determined visually perceptible parameters, wherein the display comprises an array of pixels and/or cells, each pixel and/or cell corresponding to a respective contact center object and a plurality of the pixels and/or cells having different visually perceptible parameters.

### FIELD

The present disclosure is generally directed toward communications and more specifically toward contact centers.

### BACKGROUND

A contact center manages all client contacts of a business or other entity through a variety of mediums, such as telephone, fax, letter, e-mail and, increasingly, online live chat. Distinct from call centers, that purely handle telephone correspondence, contact centers have a variety of roles that combine to provide an all encompassing solution to client and customer contact. Contact centers have many different configurations.

A common type of contact center employs queues of contact center agents and work items and complex work assignment algorithms in an attempt to provide optimal customer service. For example, in skill-based queues a work item queue is paired with a corresponding resource queue. When work items are received at the Automated Contact Distributor (ACD), the attributes of the work item are analyzed, and the work item is placed in a specific queue based on its attributes. Similarly, when a contact center resource (often an agent) comes on line they are assigned to one or more resource queues that also have a corresponding skillset associated therewith. Since skill queues are provided in work item/resource pairs, the next available agent in a resource queue is assigned the next work item waiting in the work item queue. While there have been some solutions to make this queue and assignment structure more flexible, every solution has always been hampered by the notion of utilizing a number of queues.

To improve efficiency, a contact center will typically segment contacts into many different queues. This segmentation may be by service, language, media type, region, and/or customer type. This can quickly result in many thousands of queues. Each of these queues needs to be configured, managed, monitored and reported on. Also, as agents gain new skills and improve their expertise levels, there is a need to constantly reassign agents to queues. Furthermore, when an agent gains new skills there is a significant cost in administration and operational costs of the contact center. Complexity increases because agents are typically in multiple queues simultaneously, and the new skills of an agent need to be updated in all relevant queues. Updating these changes in agent skills is a time-consuming and expensive task, which usually has to be performed with some amount of manual oversight. All of these factors add significant complexity and cost to the running of the center.

To address these issues, a queueless contact center has been developed. A queueless contact center discards queues and uses pools of resources, work items and qualifier sets and creates a qualification bit map for each pool. One-to-one optimal matching of work items and resources can be achieved by determining which resources are qualified to be assigned to a selected work item, which qualified resources are eligible to be assigned to the selected work item, and which eligible resources are most suitable to be assigned to the selected work item. The bit maps can enable ultra-fast mapping to determine which of the various resources is most suitable to be assigned to the selected work item.

Despite these advancements in contact center design, contact centers still need improved efficiency and higher levels of customer satisfaction through more effective contact center management. Contact center management, to keep pace with contact center design enhancements, requires ever more complex systems and highly skilled operational and management staff.

### SUMMARY

These and other needs are addressed by the various aspects, embodiments, and/or configurations of the present disclosure.

This disclosure is directed to a microprocessor executable analytic module that can:

(a) determine, for each of a number of selected contact center objects, a visually perceptible parameter based on contact center information and/or a performance parameter; and

(b) provide a display incorporating the determined visually perceptible parameters.

The display can include an array of pixels and/or cells, in which each pixel and/or cell corresponds to a respective contact center object and has different visually perceptible parameters or common visually perceptible parameters of differing magnitudes. For example, the display can be configured by the supervisor or others to display values, colors, and other visually perceptible parameters that easily show whether or not an algorithm is random and working. As will be appreciated, a normal set of calls accepted by agents generally shows up in data as relatively random, with no obvious patterns being discernible. By way of illustration, skills-based routing can show a stratification of agents, and a color scheme can indicate how busy certain agents are. The busy versus non-busy patterns can be visibly different and require only moments to recognize.

Typically, the pixels and/or cells correspond to a common type of contact center resource and/or work item, and the visually perceptible parameters are based on, related to, or a function of a common type of contact center information and/or performance parameter.

The display can be based on any kind of contact center information and/or performance parameter that provides an operational view of a contact center function, operation, and/or performance level.

When the visually perceptible parameter is based on the received contact center information, the information, for instance, can include but is not limited to one or more of contact type code, media code, contact part ID, contact ID, state ID, contact media interaction start datetime, party ID, business role code, party role start datetime, wait treatment ID, active media mask, contact part delivery source code, UCID, contact part datetime started, contact part datetime stopped, observing call flag, trunk ID, contact part routing method code, contact part purpose code, extension ID, routing construct ID, contact part subject, contact participation group ID, contact direction code, malicious call flag, queue priority, login ID, login start date/time, data source ID, reschedule datetime, contact control indicator, state reason ID, calling number ID, and dialed number purpose ID.

When the visually perceptible parameter is based on the received performance parameter, the parameter can, for instance, include but is not limited to one or more of blockage, abandon rate, service level, ASA, first contact resolution rate, transfer rate, communication skill, adherence to procedures, agent occupancy, staff shrinkage, schedule efficiency, schedule adherence, AHT, ACW, system availability and accessibility, conversion rate, average wait time, expected wait time, predicted wait time, estimated wait time, actual wait time, number of contacts accepted by an agent over a selected period of time, number of contacts missed or declined by an agent over a selected period of time, value earned by the agent by servicing one or more work items, percentage utilization of a contact center resource, percentage realization of a contact center policy and/or goal, and up-sell/cross-sell rate.

Each pixel and/or cell can be linked to a set of data structures corresponding to the respective contact center object, whereby selection of a pixel and/or cell causes the linked set of data structures to be presented visually to a viewer, thereby providing the viewer with additional information not otherwise visible on the display.

Certain activities can be configured as triggers. For example, when a number of missed calls reaches 50% in a contact center that typically has no more than 10% (or higher on special days), an email or pop-up can be sent to a supervisor as an alert to check the system and take corrective action, if necessary. The email or pop-up can specify the specific work assignment algorithm experiencing or detecting the problem.

The analytic module can further:

(a) compare the pattern with one or more historic and/or selected and/or determined patterns;

(b) determine a difference between the pattern and the one or more historic and/or selected and/or determined patterns; and

(c) apply one or more rules to determine whether the difference is indicative of an unacceptable operational state or condition of the contact center.

The present disclosure can provide a number of advantages depending on the particular aspect, embodiment, and/or configuration. For example, it can provide a hot-spot viewer as a mechanism to detect anomalies, such as work assignment algorithm malfunctions, system or component outages, improperly or inefficiently functioning groups of contact center resources, and improper workload distributions, manually or automatically. The easy visualization patterns can allow for instantaneous analysis of abnormal algorithmic behavior by a supervisor or software pattern recognition or matching system. The analytic module can take live and interactive data from a contact center in real time and create a visual and/or organic matching mechanism providing an agent and/or supervisor with holistic data and visual status changes to facilitate early intervention when something looks different rather than waiting for a catastrophic failure. The display does not employ confusing contour lines or complex mathematical equations to create a contoured set of data points displayed as local maximums. The solution, for instance, can allow for classification of a species rather than a mathematical function used for data collection, storage and presentation. The display can enable a viewer not only to determine readily the delta or differential of the displayed pattern when compared to patterns associated with acceptable contact center operational states but also to determine a velocity or rate of change and react appropriately. The analytic module can enable contact center management to keep pace with contact center design enhancements using a simple and inexpensive system and less highly skilled operational and management staff.

These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

The term “pattern recognition” refers to the assignment of a label or other description to a given input value. An example of pattern recognition is classification, which attempts to assign each input value to one of a given set of classes (for example, determine whether a given email is “spam” or “non-spam”). However, pattern recognition is a more general problem that encompasses other types of output as well. Other examples are regression, which assigns a real-valued output to each input; sequence labeling, which assigns a class to each member of a sequence of values (for example, part of speech tagging, which assigns a part of speech to each word in an input sentence); and parsing, which assigns a parse tree to an input sentence, describing the syntactic structure of the sentence. Pattern recognition algorithms generally aim to provide a reasonable answer for all possible inputs and to perform “most likely” matching of the inputs, taking into account their statistical variation. This is opposed to “pattern matching” algorithms, which look for exact matches in the input with pre-existing patterns. A common example of a pattern-matching algorithm is regular expression matching, which looks for patterns of a given sort in textual data and is included in the search capabilities of many text editors and word processors. In contrast to pattern recognition, pattern matching is generally not considered a type of machine learning, although pattern-matching algorithms (especially with fairly general, carefully tailored patterns) can sometimes succeed in providing similar-quality output to the sort provided by pattern-recognition algorithms.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram of a communication system in accordance with embodiments of the present disclosure;

FIG. 2 depicts a display of contact center information in accordance with embodiments of the present disclosure;

FIG. 3 depicts an exemplary display of contact center information in accordance with embodiments of the present disclosure;

FIG. 4 depicts an exemplary display of contact center information in accordance with embodiments of the present disclosure;

FIG. 5 depicts an exemplary display of contact center information in accordance with embodiments of the present disclosure;

FIG. 6 depicts an exemplary display of contact center information in accordance with embodiments of the present disclosure;

FIG. 7 depicts an exemplary display of contact center information in accordance with embodiments of the present disclosure;

FIG. 8 is a flow diagram depicting a method of operation of a performance analyzer in accordance with embodiments of the present disclosure;

FIG. 9 is a flow diagram depicting a method of operation of a presenter in accordance with embodiments of the present disclosure; and

FIG. 10 is a flow diagram depicting a method of a pattern analyzer in accordance with embodiments of the present disclosure.

### DETAILED DESCRIPTION

### The Contact Center

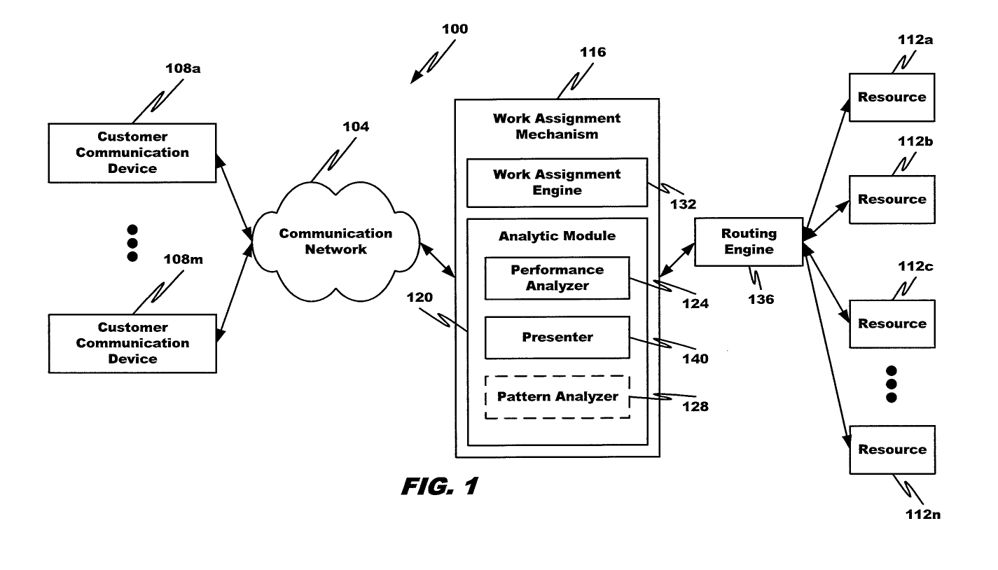

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108a-m to a work assignment mechanism 116, which may be owned and operated by an enterprise administering a contact center in which a plurality of resources 112a-n are distributed to handle incoming work items (in the form of contacts) from the customer communication devices 108a-m.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Voice over Internet Protocol (VoIP) network, a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108a-m may correspond to customer communication devices. In accordance with at least some embodiments of the present disclosure, a customer may utilize their communication device 108a-m to initiate a work item, which is generally a request for a processing resource 112a-n. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The work assignment mechanism 116 may employ any queue-based or queueless work assignment algorithm. Examples of queue-based work assignment skill-based algorithms include, without limitation, a fairness algorithm, pacing algorithm (which inserts rests into the agents work queue), value-based algorithms, limited algorithms (such as Business Advocate™ by Avaya, Inc.), and outsourcing algorithms. Other algorithms may consider other types of data inputs and/or may treat certain data inputs differently.

The format of the work item may depend upon the capabilities of the communication device 108a-m and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112a-n is assigned to the work item representing that communication at which point the work assignment mechanism 116 passes the work item to a routing engine 136 to connect the communication device 108a-m which initiated the communication with the assigned resource 112a-n.

Although the routing engine 136 is depicted as being separate from the work assignment mechanism 116, the routing engine 136 may be incorporated into the work assignment mechanism 116 or its functionality may be executed by the work assignment engine 132.

In accordance with at least some embodiments of the present disclosure, the communication devices 108a-m may comprise any type of known communication equipment or collection of communication equipment. Examples of a suitable communication device 108a-m include, but are not limited to, a personal computer, laptop, Personal Digital Assistant (PDA), cellular phone, smart phone, telephone, or combinations thereof. In general each communication device 108a-m may be adapted to support video, audio, text, and/or data communications with other communication devices 108a-m as well as the processing resources 112a-n. The type of medium used by the communication device 108a-m to communicate with other communication devices 108a-m or processing resources 112a-n may depend upon the communication applications available on the communication device 108a-m.

In accordance with at least some embodiments of the present disclosure, the work item is sent toward a collection of processing resources 112a-n via the combined efforts of the work assignment mechanism 116 and routing engine 136. The resources 112a-n can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112a-n may be owned and operated by a common entity in a contact center format. In some embodiments, the work assignment mechanism 116 may be administered by multiple enterprises, each of which has their own dedicated resources 112a-n connected to the work assignment mechanism 116.

In some embodiments, the work assignment mechanism 116 comprises a work assignment engine 132 which enables the work assignment mechanism 116 to make intelligent routing decisions for work items. In some embodiments, the work assignment engine 132 is configured to administer and make work assignment decisions in a queueless contact center, as is described in U.S. patent application Ser. No. 12/882,950, the entire contents of which are hereby incorporated herein by reference.

More specifically, the work assignment engine 132 can determine which of the plurality of processing resources 112a-n is qualified and/or eligible to receive the work item and further determine which of the plurality of processing resources 112a-n is best suited to handle the processing needs of the work item. In situations of work item surplus, the work assignment engine 132 can also make the opposite determination (i.e., determine optimal assignment of a work item resource to a resource). In some embodiments, the work assignment engine 132 is configured to achieve true one-to-one matching by utilizing bitmaps/tables and other data structures.

The work assignment engine 132 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

### Contact Center Analytic Module

In addition to comprising the work assignment engine 132, the work assignment mechanism 116 may also comprise an analytic module 120. The analytic module 120 may comprise a performance analyzer 124 to collect and analyze contact center information and determine historical and/or real time performance measures, a presenter 140 to render the collected contact center information and determined performance measures in a display for contact center administration, and, optionally, a pattern analyzer 128 to identify unacceptable differences in the rendered information when compared to acceptable information and/or unacceptable temporal velocity or rate of change of the rendered information. The analytic module 120 can be a modified form of IQ™, Operational Analyst™, Contact Flow Analytics™, Desktop Wallboard™, Avaya Aura® Performance Center™, Enterprise Work Assignment™, and/or Avaya Aura® Workforce Optimization™, all by Avaya, Inc.

The performance analyzer 124 collects and analyzes contact center information and, based on the analyzed contact center information, determines historical and/or real time performance measures. Contact center information includes one or more of contact type code, media code (which identifies the type of media/medium used during the contact part), contact part ID (which uniquely identifies the contact part), contact ID (which uniquely identifies the contact of which the contact part is a subpart), state ID (which identifies the state of the corresponding monitored endpoint to which the contact part corresponds), contact media interaction start datetime (the date/time that the contact media interaction started), party ID, business role code, party role start datetime, wait treatment ID, active media mask (a mapping of possible media types and their direction), contact part delivery source code, UCID (Universal Call Identifier), contact part datetime started (the date/time that the contact part started), contact part datetime stopped (the date/time that the contact part stopped), observing call flag, trunk ID, contact part routing method code, contact part purpose code, extension ID, routing construct ID, contact part subject (a text description of the subject of the message), contact participation group ID, contact direction code, malicious call flag, queue priority, login ID, login start date/time, data source ID, reschedule datetime (time stamp indicating when the contact connected to this part will be rescheduled to make another attempt), contact control indicator, state reason ID, calling number ID (the number dialed by the originator of the contact), and dialed number purpose ID. Performance measures include blockage (which indicates what percentage of customers will not be able to access the center at a given time due to insufficient network facilities in place), abandon rate (which measure the number of abandons as well as the abandon rate since both correlate with retention and revenues), service level and/or ASA (which is the percentage of contacts that are answered in a defined wait threshold, the most common speed of answer measure in the contact center, and most commonly stated as x percent of contacts handled in y seconds or less, while average speed of answer (ASA) represents the average wait time of all contacts in the period), first contact resolution rate (which is the percentage of transactions that are completed within a single contact, often called the “one and done” ratio or first contact resolution (FCR) rate, can be an important measure of quality, and gauges the ability of the center, as well as of an individual, to accomplish an interaction in a single step without requiring a transfer to another person or area, or needing another transaction at a future time to resolve the customer issue), transfer rate (which can be expressed as the transfer percentage and is an indication of how many contacts have to be transferred to another person or place to be handled), communication skills (which is degree to which general communications skills and etiquette are displayed by a resource and generally measured via observation or some form of quality monitoring as an individual gauge of performance), adherence to procedures (which measures a resource's adherence to procedures such as workflow processes or contact scripts), agent occupancy (which is a measure of actual time busy on customer contacts compared to available or idle time, is calculated by dividing workload hours by staff hours, and can be an important measure of how well the contact center has scheduled its staff and how efficiently resources are being used (e.g., if occupancy is too low, agents are sitting around idle with not enough to do and, if occupancy is too high, the personnel may be overworked)), staff shrinkage (which is the percentage of time that employees are not available to handle contacts and is commonly classified as non-productive time, such as meeting and training time, breaks, paid time off, off-phone work, and general unexplained time where agents are not available to handle customer interactions), schedule efficiency (which measures the degree of overstaffing and understaffing that exist as a result of scheduling design), schedule adherence (which measures the degree to which the specific hours scheduled are actually worked by the agents and is an overall contact center measure and can be one of the most important team and individual measures of performance since it can have a great impact on productivity and service), AHT/ACW (which is a common measure of contact handling, the average handle time (AHT), made up of talk time plus after-contact work (ACW), and, to accommodate differences in contact patterns, normally measured and identified by time of day as well as by day of week), system availability and accessibility (which is a measure of the response time of contact center computer systems), conversion rate (which refers to the percentage of transactions in which a sales opportunity is translated into an actual sale and can be measured as an absolute number of sales or as a percentage of contacts that result in a sale), average, expected, predicted, estimated, and/or actual wait time (of a work item for servicing), number of contacts accepted by an agent over a selected period of time, percentage utilization of a contact center resource, percentage realization of a contact center policy and/or goal, and up-sell/cross-sell rate (which refers to cost per contact or cost per minute to handle the contact workload). As will be appreciated, this is not an exhaustive list, and other types of contact center information and/or performance metrics may also be employed. Any of the contact center information and/or performance metrics can be expressed as a percent realization compared to contact center goals, policies, and/or thresholds for the type of contact center information and/or performance metric.

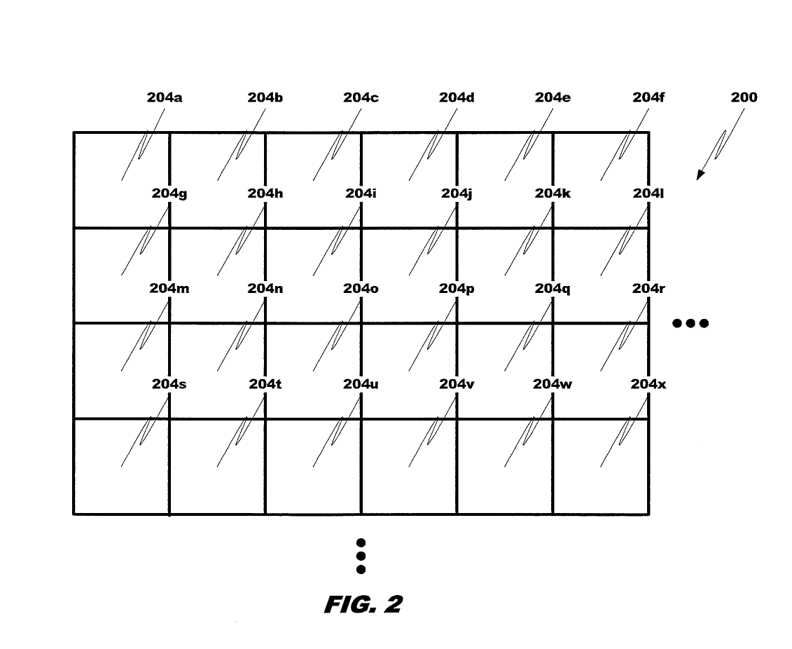

The presenter 140 receives the collected contact center information and determined performance measures and renders it a display for contact center administration. An example of the rendered display is shown in FIG. 2. In FIG. 2, an array of pixels, or cells 204a-x compose the display 200. Each pixel can refer to any contact center object but typically refers to a corresponding work item or resource (such as a human agent). A value is associated with each pixel and represents, or is proportional or related to, a magnitude of a collected information and/or performance measure associated with the corresponding work item or resource. The value can be indicative of a visually perceptible parameter, such as color, color intensity or shade, pixel and/or cell border dimension (e.g., width, height, and/or depth of the pixel and/or cell), numerical, alphabetical, and/or alphanumeric character size (which is contained in the pixel), pixel and/or cell border width, color, color intensity, color shade, color intensity and/or shade as a function of time (e.g., whether the pixel and/or cell or a component thereof is pulsing, flashing, and/or the frequency of pulsing or flashing of the pixel and/or cell or component thereof), and the like. For example, a low performance metric can be associated with a more intense color while a high performance metric can be associated with a less intense color or vice versa. In another example, the value of the performance metric is linked to the color selected, such as red for a low performance metric and green for a high performance metric. Combinations of these examples are also possible.

Each pixel and/or cell can be linked, indexed, or hyperlinked to a data structure containing the same or other or different collected information and/or performance metrics about the respective contact center object. Hovering over the pixel and/or cell with a cursor can cause the linked data structures to appear in proximity to the selected pixel and/or cell. This display 200 can act as a hot-spot, color-coded visual dynamic representation of contact center data, thereby providing a contact center administrator, at a glance, with instant feedback, by the visually displayed pattern, on whether there is abnormal, aberrant, dysfunctional, anomalous, or otherwise unacceptable contact center behavior and a potential cause of the behavior.

The presenter 140 can be configured to use any kind of contact center information or metric that provides an operational view of contact center information and/or resource performance and/or work item service. The presenter 140 can also display simultaneously a typical normal operational view of the contact center information and/or resource performance and/or work item service. By comparing the current display with a “normal” or “acceptable” display, the contact center administrator can readily determine if current contact center performance is acceptable or unacceptable. The percentage of the pixels or cells having a selected (common) visually perceptible parameter and/or the value of the visually perceptible parameter associated with the pixel and/or cell can indicate the severity of any contact center operational issues.

The value of the visually perceptible parameter for a selected pixel and/or cell can be used as a trigger. For example, if the value reaches a first threshold, an email or pop-up or other type of warning can be provided to a contact center administrator to check the display 200 and take corrective action, if necessary or desired. The warning can specify which specific contact center algorithm, queue, resource, work item, and/or other contact center object is experiencing or detecting the operational problem. Multiple triggers can be selected, each requiring a different action to be taken.

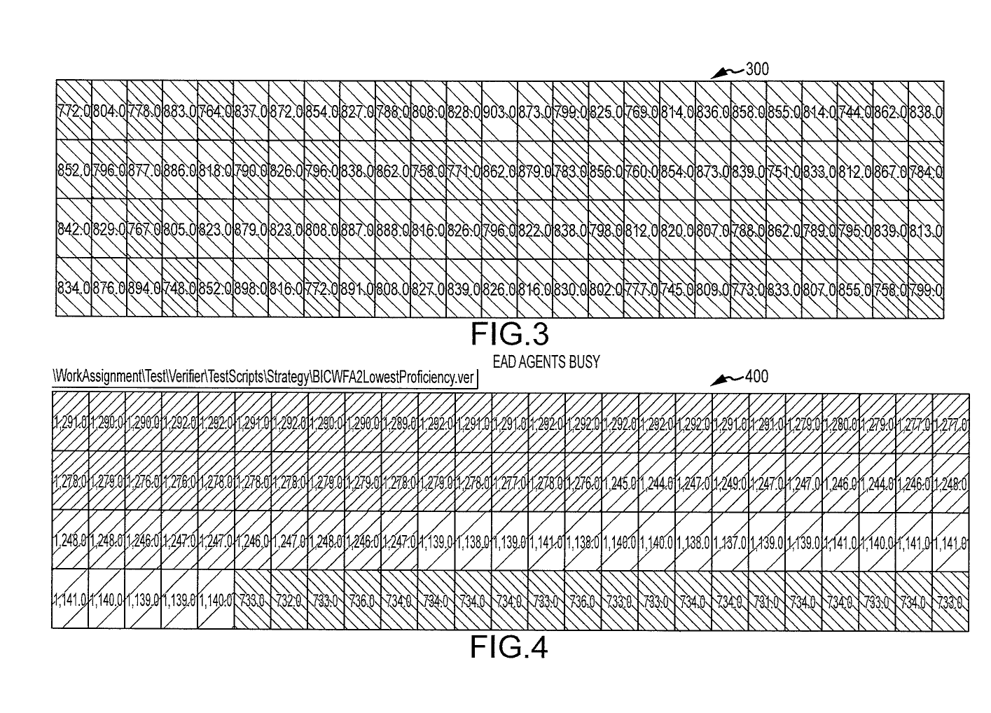

A number of examples will be discussed to illustrate aspects of the disclosure. Referring to FIG. 3, a display 300 is provided that illustrates a number of calls accepted by an agent. Each pixel and/or cell corresponds to a different agent and contains a number indicating the respective number of calls accepted by the corresponding agent. In other words, all of the pixels or cells relate to a common parameter, namely the number of calls accepted by the referenced agents. All of the pixels or cells have a common color (green) with the intensity or shade of the color being proportional to the number of calls accepted. The display is relatively random with no obvious pattern. This display can be illustrative of a normal operational state of the contact center. The area of the display occupied by a selected shade of green can indicate roughly the percentage of agents accepting roughly the same number of calls. By location of a selected shade of green, contact center administrators can determine what kind and/or skill level of agents are available, and by the values in each pixel and/or cell what the cost may be.

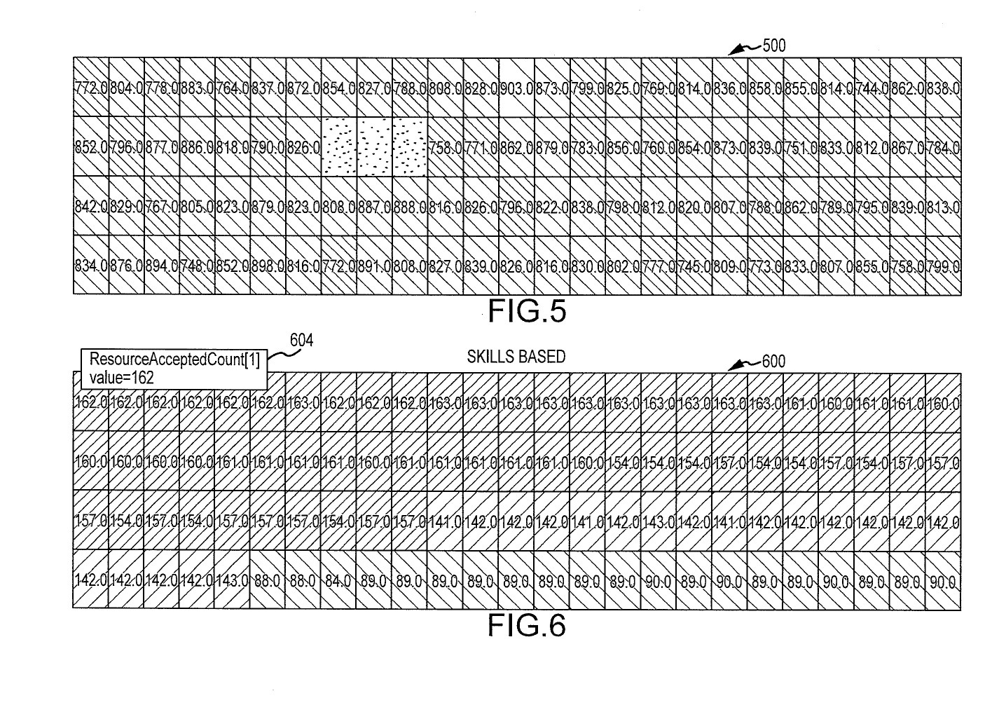

Referring to FIG. 4, a display 400 is depicted that also illustrates the number of calls accepted by an agent in a skills-based routing work assignment algorithm. Unlike the display 300, the display 400 uses different colors to represent the performance measure of number of calls accepted. The particular color selected by the presenter is a function of the magnitude of the performance measure, which in this case is the number of accepted calls. For a number of calls over 1,200, the color selected for the pixel and/or cell is a shade of orange, with the shade or intensity of the color being a function of the performance measure magnitude. For a number of calls over 1,000 but less than 1,200, the color selected for the pixel and/or cell is a shade of yellow, with the shade or intensity of the color being a function of the performance measure magnitude. For a number of calls less than 1,000, the color selected for the pixel and/or cell is a shade of blue, with the shade or intensity of the color being a function of the performance measure magnitude. The area of the display occupied by a selected color can indicate roughly the percentage of agents accepting roughly the same number of calls. The display 400 shows the stratification of agents expected in skills-based routing, with the expert or more highly skilled agents in the top row of the display 400 generally receiving more calls than the less skilled agents in the middle row, and the agents in the middle row receiving more calls than the least skilled agents in the bottom row.

Referring to FIG. 5, a display 500 is depicted that also illustrates the number of calls accepted by agents in a skills-based routing work assignment algorithm. Like the display 400, the display 500 uses different colors to represent the performance measure of number of calls accepted. As in the case of display 400, the particular color selected by the presenter is a function of the magnitude of the performance measure, which in this case is the number of accepted calls. For an agent accepting at least one call, the color selected for the pixel and/or cell is a shade of green, with the shade or intensity of the color being a function of the performance measure magnitude. For no calls accepted, the color selected for the pixel and/or cell is blue. The display 500 is anomalous, or unacceptable to a contact center administrator, because the three moderately skilled agents corresponding to the blue-colored pixels or cells are accepting no calls. This problem is readily visible by a quick glance at the display 500 and does not require an administrator to laboriously identify the problem by reviewing numerous contact center performance reports. By selecting various types of such displays involving differing types of contact center information and/or performance measures, the administrator can determine quickly what is causing the abnormal contact center behavior, including identifying which work assignment algorithm is involved.

Referring to FIG. 6, a display 600 is depicted that also illustrates the number of calls accepted by agents in a skills-based routing work assignment algorithm. Like the displays 400 and 500, the display 600 uses different colors to represent the performance measure of number of calls accepted. As in the case of displays 400 and 500, the particular color selected by the presenter is a function of the magnitude of the performance measure, which in this case is the number of accepted calls. For a number of calls over 100, the color selected for the pixel and/or cell is a shade of orange, with the shade or intensity of the color being a function of the performance measure magnitude. For a number of calls of 1 or over but less than 100, the color selected for the pixel and/or cell is a shade of green, with the shade or intensity of the color being a function of the performance measure magnitude. The display 600 shows the stratification of agents expected in skills-based routing, with the expert or more highly skilled agents in the top or first row of the display 600 generally receiving more calls than the less skilled agents in the second row from the top, the agents in the second row receiving more calls than the lesser skilled agents in the third row from the top, and the least skilled agents in the bottom (or fourth) row receiving fewer calls than the more highly skilled agents in the first, second, and third rows. The pop up 604, which appears by the user selecting the pixel and/or cell in the upper left position of the table provides more contact center information (e.g., “Resource Accepted Contact value=162.0”). As will be appreciated, any contact center information or performance measure may be referenced in the pop up, including agent name, agent skill(s), agent skill level, another relevant performance measure for the agent, and the like, and the pixel and/or cell may be selected by any suitable technique, such as by a cursor or key press.

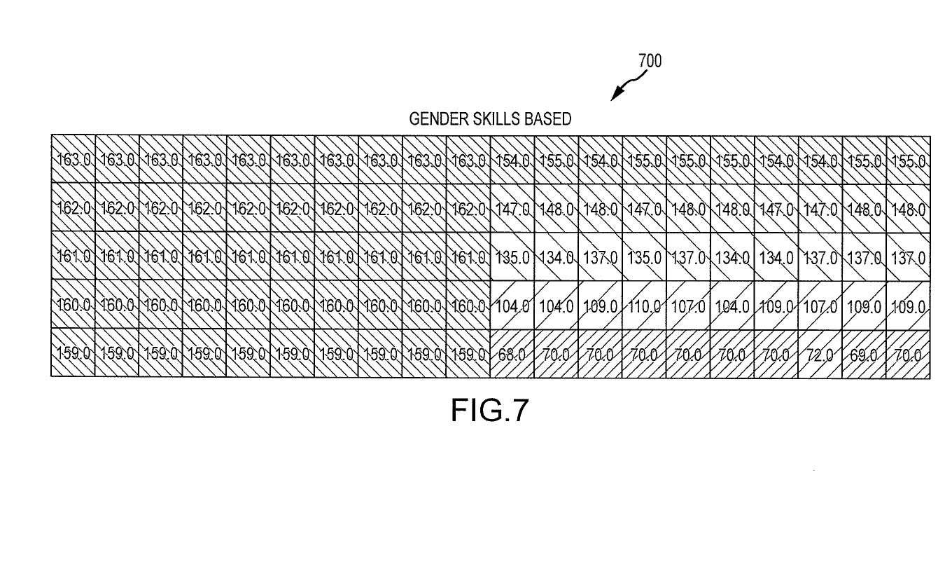

Referring to FIG. 7, a display 700 is depicted that also illustrates the number of calls accepted by agents in a skills-based routing work assignment algorithm. Like the displays 400-600, the display 700 uses different colors to represent the performance measure of number of calls accepted. As in the case of displays 400-600, the particular color selected by the presenter is a function of the magnitude of the performance measure, which in this case is the number of accepted calls. For a number of calls over 125, the color selected for the pixel and/or cell is a shade of orange, with the shade or intensity of the color being a function of the performance measure magnitude. For a number of calls of 1 or over but less than 125, the color selected for the pixel and/or cell is a shade of green, with the shade or intensity of the color being a function of the performance measure magnitude. The display 700 shows the stratification of agents expected in a gender-based skills routing (using a gender-based skill split), with the expert or more highly skilled agents in the top (or first) row of the display 700 generally receiving more calls than the less skilled agents in the middle or second row, the agents in the second row from the top receiving more calls than the lesser skilled agents in the third row from the top, the agents in the fourth row from the top receiving fewer calls than the more highly skilled agents in the top, second, and third rows and the agents in the bottom (or fourth) row receiving fewer calls than the more highly skilled agents in the first, second, and third rows, and the agents in the fourth row from the top receiving fewer calls than the more highly skilled agents in the top, second, and third rows and the agents in the bottom (or fifth) row receiving fewer calls than the more highly skilled agents in the first, second, third, and fourth rows. The left-half of the display 700 shows female agents while the right-half of the display 700 are male agents. The display 700 is thus a gender-based routing with priority given to female callers. The work assignment algorithm distributes calls evenly to female agents and distributes calls like normal skills-based for males (since the primary criterion was unmet).

Innumerable other display configurations are possible. For example, a work item-centric display can be employed in which the pixels or cells each represent a pending and/or serviced work item. The contact center information and/or performance measures used to determine the visually perceptible parameter could be wait time, percentage of current wait time when compared to wait time goals or thresholds, and the like.

The pattern analyzer 128 is a software pattern recognition and/or matching algorithm that compares the pattern in the display and/or the pixel and/or cell data with one or more historic and/or selected and/or determined patterns, determines a difference between the pattern in the display and/or the pixel and/or cell data and the one or more historic and/or selected and/or determined patterns, and, for the differences, applies rules to determine whether the pattern in the display and/or the pixel and/or cell data is indicative of an unacceptable operational state or condition of the contact center. The pattern analyzer can be artificially intelligent software, such as a neural network or other artificially intelligent or adaptive system, with the learned ability to simulate and/or characterize contact center behavior based on the pattern in the display and/or the pixel and/or cell data.

### Contact Center Analytic Module Operation

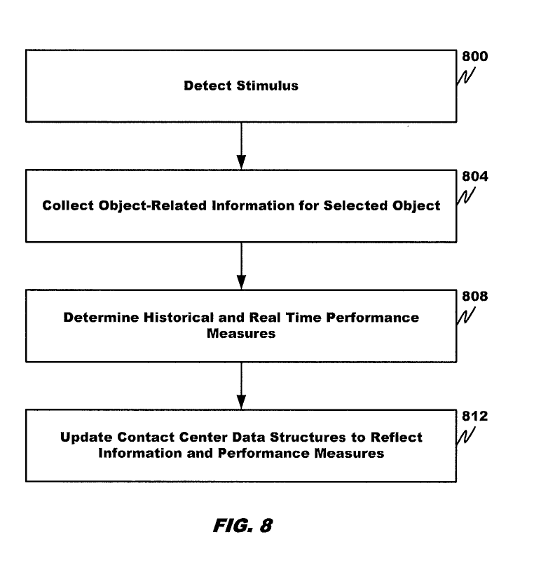

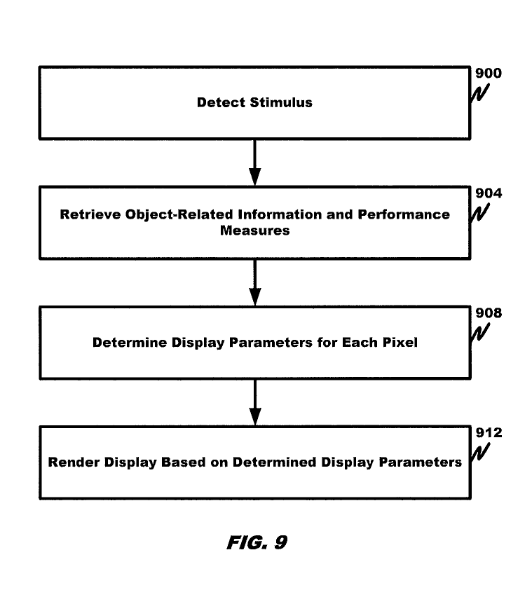

Referring to FIG. 8, operation of the performance analyzer 124 will be discussed.

In step 800, the performance analyzer 124 detects a stimulus. Exemplary stimuli include request by a contact administrator for generation of a display for one or more specified items of contact center information and contact center performance measures, a signal indicating that a threshold has been triggered as to a specified item of contact center information and/or contact center performance measure (for which the display is then generated), a temporal trigger, a display update request, and the like.

In step 804, the performance analyzer 124 collects relevant contact center information required by the stimulus and/or by the performance measure required by the stimulus.

In step 808, the performance analyzer 124 determines and/or updates a historical and/or real time performance measure based on the contact center information collected in step 804.

Control then passes to step 812, in which step the performance analyzer 124 updates contact center data structures to reflect the collected contact center information and/or determined performance measure. The performance analyzer 124, when appropriate, then notifies the presenter 140 to update and/or provide a display containing the collected contact center information and/or performance measure.

Referring to FIG. 9, operation of the presenter 140 will be discussed.

In step 900, the presenter 140 detects a stimulus, such as a notification from the performance analyzer 124 or any of the stimuli referenced above. The stimulus may identify the contact center object (whether collected contact center information and/or a performance measure) to be provided by a display.

Control then passes to step 904 in which the presenter 140 retrieves the contact center object. The contact center object is typically a type of contact center information (such as resource and/or work item information) and/or a performance measure.

The presenter 140, in step 908, determines the display parameters for each pixel and/or cell. As noted, the display parameters are commonly the visually perceptible parameter, the resources and/or work items to be associated with each pixel and/or cell, and the other information to be included in each pixel and/or cell (such as the number of calls accepted by the corresponding agent and used to select the visually perceptible parameter).

The presenter 140, in step 912, renders the display based on the determined display parameters.

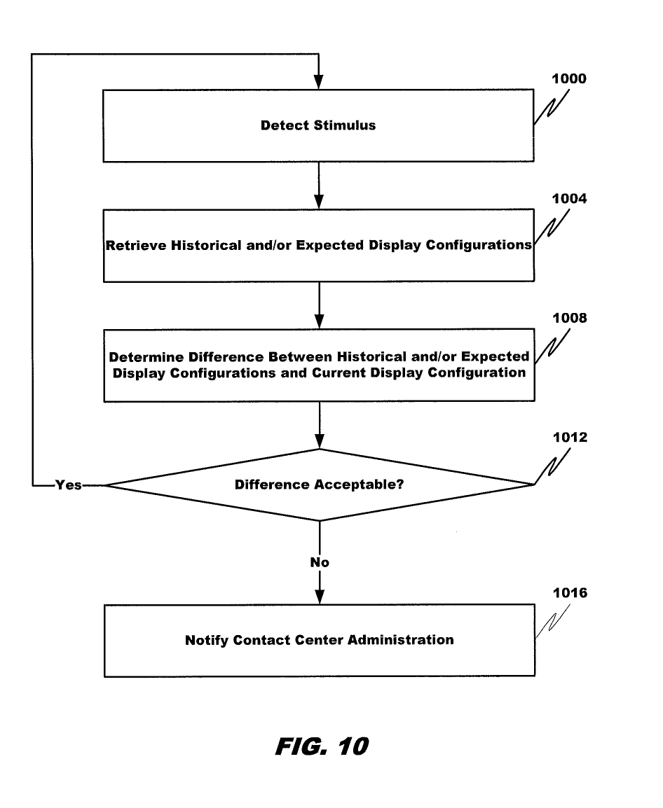

Referring to FIG. 10, operation of the pattern analyzer 128 will be discussed.

The pattern analyzer 128, in step 1000, detects a stimulus. The stimulus can be, for example, a signal from the performance analyzer 124 or presenter 140 or any of the stimuli referenced above.

In step 1004, the pattern analyzer 128 retrieves historical and/or expected display configurations and/or information for the referenced type of contact center information and/or performance measures upon which the display or display information is based. The selection of the configurations or patterns can be based on any number of factors, including past contact center performance, current performance of other types of contact center information and/or performance measures, and the like.

In step 1008, the pattern analyzer 128 determines a difference between the retrieved display configuration(s) and/or information and the current display configuration and/or information.

Control then passes to decision diamond 1012 which requires the pattern analyzer 128 to determine if the difference is acceptable. This decision is typically rule and/or threshold based. When the difference is deemed to be acceptable, the pattern analyzer 128 returns to step 1000. When the difference is not acceptable, the pattern analyzer proceeds to step 1016.

In step 1016, the pattern analyzer 128 notifies contact center administration of the unacceptable contact center behavior or performance.

The exemplary systems and methods of this disclosure have been described in relation to contact or interaction centers. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example one alternative embodiment can describe an interchange on every piece of equipment where all resources can be designated as having skills.

In another alternative embodiment, the techniques described herein are applied to a grid-based contact center where the workload is distributed across everything, as described in US Patent Application No. 2010/0296417, which is incorporated herein by this reference.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving, by a microprocessor executable analytic module, contact center information and/or a performance parameter;
determining, by the microprocessor executable analytic module and for each of a plurality of selected contact center objects, a visually perceptible parameter based on the received contact center information and/or a performance parameter; and
providing by the microprocessor executable analytic module, a display incorporating the determined visually perceptible parameters, wherein the display comprises an array of pixels and/or cells, each pixel and/or cell corresponding to a respective contact center object and a plurality of the pixels and/or cells having different visually perceptible parameters and/or common visually perceptible parameters of differing magnitudes.

2. The method of claim 1, wherein the contact center objects are one of contact center resources and work items, wherein the visually perceptible parameter is one or more of a color, a shade of color, intensity of the color, character size, pixel and/or cell border dimension, pixel and/or cell border width, and color intensity and/or shade as a function of time, and wherein each pixel and/or cell is linked to a set of data structures corresponding to the respective contact center object, whereby selection of a pixel and/or cell causes the linked set of data structures to be presented visually to a viewer.

3. The method of claim 1, wherein the visually perceptible parameter is based on the received contact information and wherein the received contact center information includes one or more of contact type code, media code, contact part ID, contact ID, state ID, contact media interaction start datetime, party ID, business role code, party role start datetime, wait treatment ID, active media mask, contact part delivery source code, UCID, contact part datetime started, contact part datetime stopped, observing call flag, trunk ID, contact part routing method code, contact part purpose code, extension ID, routing construct ID, contact part subject, contact participation group ID, contact direction code, malicious call flag, queue priority, login ID, login start date/time, data source ID, reschedule datetime, contact control indicator, state reason ID, calling number ID, and dialed number purpose ID.

4. The method of claim 1, wherein the visually perceptible parameter is based on the received performance parameter and wherein the received performance parameter includes one or more of blockage, abandon rate, service level, ASA, first contact resolution rate, transfer rate, communication skill, adherence to procedures, agent occupancy, staff shrinkage, schedule efficiency, schedule adherence, AHT, ACW, system availability and accessibility, conversion rate, average wait time, expected wait time, predicted wait time, estimated wait time, actual wait time, number of contacts accepted by an agent over a selected period of time, number of contacts missed or declined by an agent over a selected period of time, value earned by the agent by servicing one or more work items, percentage utilization of a contact center resource, percentage realization of a contact center policy and/or goal, and up-sell/cross-sell rate.

5. The method of claim 1, wherein the visually perceptible parameters in the pixels and/or cells collectively define a visually perceptible pattern and further comprising:
comparing, by the analytic module, the pattern with one or more historic and/or selected and/or determined patterns;
determining, by the analytic module, a difference between the pattern and the one or more historic and/or selected and/or determined patterns; and
applying, by the analytic module, one or more rules to determine whether the difference is indicative of an unacceptable operational state or condition of the contact center.

6. The method of claim 1, wherein the pixels and/or cells correspond to a common type of contact center resource and/or work item and wherein the visually perceptible parameters are based on a common type of contact center information and/or performance parameter.

7. A system, comprising:
a microprocessor executable analytic module operable to:
determine, for each of a plurality of selected contact center objects, a visually perceptible parameter based on contact center information and/or a performance parameter; and
provide a display incorporating the determined visually perceptible parameters, wherein the display comprises an array of pixels and/or cells, each pixel and/or cell corresponding to a respective contact center object and a plurality of the pixels and/or cells having different visually perceptible parameters and/or common visually perceptible parameters of differing magnitudes.

8. The system of claim 7, wherein the contact center objects are one of contact center resources and work items, wherein the visually perceptible parameter is one or more of a color, a shade of color, intensity of the color, character size, pixel and/or cell border dimension, pixel and/or cell border width, and color intensity and/or shade as a function of time, and wherein each pixel and/or cell is linked to a set of data structures corresponding to the respective contact center object, whereby selection of a pixel and/or cell causes the linked set of data structures to be presented visually to a viewer.

9. The system of claim 7, wherein the visually perceptible parameter is based on the received contact information and wherein the received contact center information includes one or more of contact type code, media code, contact part ID, contact ID, state ID, contact media interaction start datetime, party ID, business role code, party role start datetime, wait treatment ID, active media mask, contact part delivery source code, UCID, contact part datetime started, contact part datetime stopped, observing call flag, trunk ID, contact part routing method code, contact part purpose code, extension ID, routing construct ID, contact part subject, contact participation group ID, contact direction code, malicious call flag, queue priority, login ID, login start date/time, data source ID, reschedule datetime, contact control indicator, state reason ID, calling number ID, and dialed number purpose ID.

10. The system of claim 7, wherein the visually perceptible parameter is based on the received performance parameter and wherein the received performance parameter includes one or more of blockage, abandon rate, service level, ASA, first contact resolution rate, transfer rate, communication skill, adherence to procedures, agent occupancy, staff shrinkage, schedule efficiency, schedule adherence, AHT, ACW, system availability and accessibility, conversion rate, average wait time, expected wait time, predicted wait time, estimated wait time, actual wait time, number of contacts accepted by an agent over a selected period of time, number of contacts missed or declined by an agent over a selected period of time, value earned by the agent by servicing one or more work items, percentage utilization of a contact center resource, percentage realization of a contact center policy and/or goal, and up-sell/cross-sell rate.

11. The system of claim 7, wherein the visually perceptible parameters in the pixels and/or cells collectively define a visually perceptible pattern and wherein the analytic module is further operable to:
compare the pattern with one or more historic and/or selected and/or determined patterns;
determine a difference between the pattern and the one or more historic and/or selected and/or determined patterns; and
apply one or more rules to determine whether the difference is indicative of an unacceptable operational state or condition of the contact center.

12. The system of claim 7, wherein the pixels and/or cells correspond to a common type of contact center resource and/or work item and wherein the visually perceptible parameters are based on a common type of contact center information and/or performance parameter.

13. A tangible, non-transient computer readable medium comprising microprocessor executable instructions that, when executed by a microprocessor:
determine, for each of a plurality of selected contact center objects, a visually perceptible parameter based on contact center information and/or a performance parameter; and
provide a display incorporating the determined visually perceptible parameters, wherein the display comprises an array of pixels and/or cells, each pixel and/or cell corresponding to a respective contact center object and a plurality of the pixels and/or cells having different visually perceptible parameters and/or common visually perceptible parameters of differing magnitudes.

14. The computer readable medium of claim 13, wherein the contact center objects are one of contact center resources and work items, wherein the visually perceptible parameter is one or more of a color, a shade of color, intensity of the color, character size, pixel and/or cell border dimension, pixel and/or cell border width, and color intensity and/or shade as a function of time, and wherein each pixel and/or cell is linked to a set of data structures corresponding to the respective contact center object, whereby selection of a pixel and/or cell causes the linked set of data structures to be presented visually to a viewer.

15. The computer readable medium of claim 13, wherein the visually perceptible parameter is based on the received contact information and wherein the received contact center information includes one or more of contact type code, media code, contact part ID, contact ID, state ID, contact media interaction start datetime, party ID, business role code, party role start datetime, wait treatment ID, active media mask, contact part delivery source code, UCID, contact part datetime started, contact part datetime stopped, observing call flag, trunk ID, contact part routing method code, contact part purpose code, extension ID, routing construct ID, contact part subject, contact participation group ID, contact direction code, malicious call flag, queue priority, login ID, login start date/time, data source ID, reschedule datetime, contact control indicator, state reason ID, calling number ID, and dialed number purpose ID.

16. The computer readable medium of claim 13, wherein the visually perceptible parameter is based on the received performance parameter and wherein the received performance parameter includes one or more of blockage, abandon rate, service level, ASA, first contact resolution rate, transfer rate, communication skill, adherence to procedures, agent occupancy, staff shrinkage, schedule efficiency, schedule adherence, AHT, ACW, system availability and accessibility, conversion rate, average wait time, expected wait time, predicted wait time, estimated wait time, actual wait time, number of contacts accepted by an agent over a selected period of time, number of contacts missed or declined by an agent over a selected period of time, value earned by the agent by servicing one or more work items, percentage utilization of a contact center resource, percentage realization of a contact center policy and/or goal, and up-sell/cross-sell rate.

17. The computer readable medium of claim 13, wherein the visually perceptible parameters in the pixels and/or cells collectively define a visually perceptible pattern and wherein the instructions, when executed:
compare the pattern with one or more historic and/or selected and/or determined patterns;
determine a difference between the pattern and the one or more historic and/or selected and/or determined patterns; and
apply one or more rules to determine whether the difference is indicative of an unacceptable operational state or condition of the contact center.

18. The computer readable medium of claim 13, wherein the pixels and/or cells correspond to a common type of contact center resource and/or work item and wherein the visually perceptible parameters are based on a common type of contact center information and/or performance parameter.

19. A display output by the executed instructions.
